(19) United States
(12) Patent Application Publication
(10) Pub. No.: US 2003/0012862 A1
(43) Pub. Date: Jan. 16, 2003

(54) Encapsulated prune powder to relieve constipation

(76) Inventor: Roger Ravi Ayres, Springfield, NJ (US)

Correspondence Address: Dr. Roger Ravi Ayres, 353 Hillside Avenue, Springfield, NJ, 07081, US

(21) Appl. No.: 10/177,379

(22) Filed: Jun. 24, 2002

Related U.S. Application Data
(60) Provisional application No. 60/283,191, filed on Jul. 16, 2001.

(51) Int. Cl. A23L 1/00

(52) U.S. Cl. 426/640

(57) ABSTRACT

An ingestible capsule consisting of dried prune powder for relieving constipation. The prune powder is prepared basically by pulverizing prunes until a low moisture prune powder results. The powder is then encapsulated and bottled. The user may take anywhere from 3 to 9 capsules daily where each capsule consists of approximately 750 milligrams of prune powder.

### CROSS-REFERENCE TO RELATED APPLICATIONS

Provisional patent application No. 60/283,191 filed Jul. 16, 2001

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Over recent years it has become apparent that people who eat low-fiber diets are more prone to constipation. Other important causes include lack of exercise, stress and anxiety, pregnancy, ignoring the urge to defecate, pain from hemorrhoids, or simply a side effect from medication.

Constipation is defined as infrequent (fewer than three a week) bowel movements. Many will report hard, dry stools that are difficult and painful to pass and some the sensation of a full rectum even after they have had a bowel movement. All of this can cause a tight, bloated feeling which can make many feel quite uncomfortable.

Many of the available treatments on the market today are helpful but are not fast and safe. Fiber supplements (bulk-forming laxatives such as psyllium) are safe but may take weeks before taking effect. Continuous use of emollient laxatives (mineral oil, docusate salts), hyperosmolar agents (lactulose, sorbitol), saline laxatives, stimulant laxatives (castor oil, senna, phenolphthalein, bisacodyl) can lead to damage to the colon itself in addition to psychological dependence.

Prune juice has been long known to relieve constipation quickly, effectively and most importantly safely. Prune juice however is not palatable to most people and thus remains one of the best-kept under-utilized secrets in medicine. This invention utilizes what we already know about prunes and makes a commercially available product that a consumer can easily take to relieve constipation.

### BRIEF SUMMARY OF THE INVENTION

Although the exact mechanism of the how prunes work as a laxative is not known, it most likely due to a combined action of fiber, sorbitol and phenolic compounds. Prunes have both soluble and insoluble fiber, which together could act in a gentle way in the lower intestine to soften the stool, increase bulk and promote bowel motility. This invention utilizes California prunes to form a low-moisture dried prune powder.

With the exception of fiber or bulk-forming laxatives, many of the available laxatives on the market can aggravate the condition. Continuous use of these laxatives (saline, emollient, hyperosmolar, and stimulant) can be habit-forming so that the body begins to rely on these laxatives. Over time, the natural “emptying” mechanisms fail to work without these drugs. Prune powder which contains the same benefits of prunes have no fat or cholesterol, provide important vitamins and minerals as well as fiber and phytochemicals, and does not become habit forming. Prunes and prune powder contain sorbitol, a sugar alcohol that can cause diarrhea in large doses such as more than 50 grams at a time. This invention taken at the recommended dosage of 3 to 9 capsules daily will contain well below the amount that could cause diarrhea thus making for a quick and safe way to relieve constipation.

### BRIEF DESCRIPTION OF THE SEVERAL VIEWS OF THE DRAWING

Not applicable

### DETAILED DESCRIPTION OF THE INVENTION

As previously mentioned, prune juice while being effective is not practical for all people due its unpleasant taste. Therefore, this invention uses prune powder (which I will have an outside licensed company manufacture) and incorporates it into a capsule form that can be swallowed. This capsule is an improvement over prune juice because it will not have an unpleasant taste and will be much more palatable.

The prune powder is made up of approximately equal amounts of soluble and insoluble forms. The water-soluble portions include pectins, gums, and mucilages while the insoluble part contains cellulose, lignin and hemicellulose. It is important to understand that even though part of the fiber is double in water it is still resistant to digestion by enzymes in the stomach and the small intestines and simply passes through with the insoluble fiber. The insoluble fiber absorbs water and provides added bulk while the soluble fiber forms gel which lubricate and stimulate shorter intestinal transit times and promotes regularity. Chemically speaking prunes are unique among fruit in that they contain high levels of sorbitol with 16%. Sorbitol is a well-known alternative sweetener but more importantly is an excellent humectant used in food formulations. It helps to retain moisture and retard dryout and staling. Sorbitol augments the intestinal function of fiber by retaining moisture and promoting gel formation. The Merck Index even describes sorbitol as being a diuretic and laxative. Prune powder also contains approximately 45 milligrams per 100 grams of magnesium. While this is not a great amount, the laxative effects of the magnesium salts are well known and this could be a contributing factor to laxation as well.

Physical characteristics—this product shall be reasonably free from defects to the extent that defects do not materially affect the appearance and eating quality as defined in U.S. Standard for Grades of Dehydrated, Low Moisture Prunes. The size is 90% by weight and shall pass through a U.S. Standard No. 20 Screen (0.0331″ opening). The color shall be reasonably uniform dark amber to brown and the organoleptic shall be characteristic of prune and free from off flavors.

Chemical characteristics—moisture is not to exceed 3.5%. Additives include calcium stearate, 1.0% maximum and no preservatives are used.

Nutritional composition include the following per 100 grams. Energy 330 kcal, protein 3 g, fat 0.5 g, total carbohydrate 89 g, total dietary fiber 9 g, total sugars 62 g, glucose 14.96 g, fructose 46.13 g, sucrose 0.56 g, calcium 72 mg, iron 3 mg, potassium 1,050 mg, sodium 5 mg and vitamin A 1,760 international units.

Microbiological analysis include the following: standard plate count—not to exceed 1,000 CFU/gram, mold and yeast—not to exceed 100 CFU/gram, coliform—not to exceed 10 CFU/gram, and salmonella and E.Coli negative.

Storage is a one-year shelf life at warehouse temperatures of 50-60 degrees F. and relative humidity of 40 to 50%.

Drying—immediately after the harvesting, the orchard-ripe fruit is taken to the dehydrator yard where it is washed, placed on large wood trays and dehydrated—in a series of scientifically controlled operations. Fully automated—strictly sanitary—and highly efficient. Here, super-sensitive thermostats take over and produce the uniform high quality prune. This is where 3 pounds of fresh fruit become 1 pound of prunes.

Low moisture prune powder shall be dry, free-flowing form of prune solids. Prune powder shall be prepared from clean, sound, pitted prunes which have been chopped or ground in preparation for dehydration, milled, screened and packed in a sealed poly-lined case. Final packaged product shall pass through a metal detector that can reject a 1.5 mm in diameter ferrous material and a 2.0 mm stainless piece. The product is manufactured in accordance with good commercial practice and under sanitary conditions to meet all standards for human consumption, including compliance with the provisions of Federal regulations and their enforcement. Again, the manufacturing of the prune powder will be outsourced to a licensed company who is in full conformance with Good Food Handling as promulgated in the U.S. Code of Regulations, Title 21, Section 110, Food and Drugs Act.

1. I claim that this prune powder formulated into a capsule will help to relieve constipation and promote bowel regularity when used as a dietary supplement.
